(19) United States
(12) Patent Application Publication
(10) Pub. No.: US 2025/0203324 A1
(43) Pub. Date: Jun. 19, 2025

(54) IMPROVED WIRELESS PAGING SYSTEM INVOKING BLUETOOTH AND POCSAG TECHNOLOGY

(71) Applicant: Long Range Solutions, LLC, Dallas, TX (US)

(72) Inventors: Michael Williams, Allen, TX (US); Michael E. Piper, Heath, TX (US)

(21) Appl. No.: 18/981,223

(22) Filed: Dec. 13, 2024

Related U.S. Application Data
(60) Provisional application No. 63/610,269, filed on Dec. 14, 2023.

(51) Int. Cl. H04W 4/12; H04W 4/80; H04W 88/06

(52) U.S. Cl. CPC H04W 4/12; H04W 4/80; H04W 88/06

(57) ABSTRACT

A Bluetooth®-to POCSAG transmission and protocol translation system as described herein, a Bluetooth®-to POCSAG transmission method as described herein, and a Bluetooth®-to POCSAG transmitter as described herein.

### FIELD OF THE INVENTION

The present Application is directed, in general, towards communication systems using Bluetooth®, and, more specifically, towards communication systems combining Bluetooth® and POCSAG for a dining or other hospitality environment.

### BACKGROUND OF THE INVENTION

The “Post Office Code Standardization Advisory Group” (“POCSAG”) is a telecommunications technology/protocol originally developed in the United Kingdom and was commonly used in the 1980s for local system pagers. Conventionally, pagers can only receive a numeric message and do not employ or require any kind of transmitter, not even to provide a “handshake” or other acknowledgement that the messages have been received by the pager.

Pager technology, using POCSAG, was originally developed to transmit only simple numeric information to the pager. One type of numeric information transmitted by POCSAG is the pager's unique identification number, which allows the pager to determine whether a signal includes an incoming message indeed intended for it, rather than for another pager, plus a numeric “message,” which is typically the callback telephone number of the sender of the page. Typically, pagers rely upon receiving a message from a dedicated local transmitter, which may typically have a power of approximately 1 to 2 watts and a range of approximately 0.25 to 2 miles. A repeater can be used to increase the range somewhat.

For a restaurant or other hospitality notification pager system, including those using common coaster-shaped notification devices handed to restaurant patrons for their temporary use, the notification is provided only by means of flashing LEDs and/or buzzers on the pager, to notify the patrons that the table, food or beverage for them is ready.

Typically, all pager transmitters provided by a particular pager manufacturer or provider will be designed to transmit at only one frequency, which is assigned to the manufacturer by the governing telecommunications licensing authority, such as the United States Federal Communications Commission (FCC). As such, a manufacturer or provider licensed for a particular frequency will provide pagers that only receive transmissions at that frequency.

For a typical restaurant or other hospitality notification system, a range of approximately 0.25 to 2 miles is adequate. With POCSAG, within a single transmitter's range, there may be many restaurants with transmitters broadcasting using the same frequency. However, because each pager has a unique system ID assigned to it by the pager manufacturer or provider, each pager will ignore messages not including its unique system ID in the address of the message. This avoids the possibility that, for example, one restaurant's transmission of a message intended for its pager at “table 10” will inadvertently activate a notification at a nearby restaurant for its own “table 10.”

Some restaurant pagers using POCSAG have a screen that is capable of displaying messages having alphabetic letters and words, such as a liquid crystal display, providing those messages are pre-stored and pre-coded in the pager. However, because the roots of POCSAG technology are in notifying the person having the pager of the telephone number of the caller, the POCSAG “message” that is sent to the pager is actually only a number. For the pager to display non-numeric messages such as words, those messages must be pre-stored in words in the pager, to be triggered by a pre-coded number, depending upon the number received. For example, if the number “3” is received, the page might display “Your table is ready now,” and if the number “4” is received, the messaged displayed might be “Your table will be ready in 15 minutes.” With this system, it is not, however, possible to display, for example, “Your table will be ready shortly,” unless that message has been pre-stored in the pager receiver and pre-programmed to be triggered by the pager receiving a particular number. Likewise, the pager would never be able to display a message that would, by its nature, need to be composed “on the fly,” such as “Your guest Ms. Smith has arrived.”

Separately from POCSAG for pagers, cellular telephones, including those capable of sending alpha-numeric texts composed by the user “on the fly,” employ a different technology and protocol for very short-range wireless transmitter/receivers, commonly known as Bluetooth®. “Bluetooth®” is not, however, suitable for use with pagers, such as restaurant and other hospitality pagers, because the reliable range of “Bluetooth” is usually only a hundred feet or so, and less in buildings. Furthermore, “Bluetooth®” technology requires the receiver to also have a transmitter in order to provide, at least, a “handshake” and “message received” confirmation, which require additional complication and power use. Wireless networks using wireless routers, though having greater range than “Bluetooth®,” often still have insufficient range for a restaurant or other hospitality application and are of far greater complexity than POCSAG. Bluetooth®” and wireless networks are inherently limited in range because, unlike POCSAG, they are designed to be of such low power that they do not require an individual license assigned by the appropriate licensing authority for the transmitter, as does POCSAG. Furthermore, both “Bluetooth” and wireless network systems require two-way transmission, including to transmit at least a “handshake” and an acknowledgement of receipt of the message, which POCSAG does not require.

Although POCSAG, Bluetooth® and wireless networks are reliable systems for their own unique applications, the present inventors have recognized that each suffers from a lack of flexibility and, further, that there is a need in the art to alleviate shortcomings of POCSAG for restaurant and other hospitality customer notification applications in not being able to display alphabetic messages composed “on the fly”.

In the present invention, to overcome the limitations of both POCSAG and wireless systems such as Bluetooth® and wireless networks, the present invention combines the advantages of “on the fly” free-form composition of alphabetic messages on a computer or cellular telephone message using “Bluetooth®” or a wireless router system, overcoming the inadequate range of those systems as compared to the much higher range for restaurant pagers using POCSAG. The present invention also takes advantage of the fact that POCSAG protocol does not require the pager receiving unit to send a “hand-shake” or other acknowledgement message back to the POCSAG transmitter, which higher level of reliability is excessive for most restaurant notification system applications. Thus, the present invention both secures the advantages of each of these separate systems, while being simpler and less power-consuming than a system requiring a transmitter in the pager.

### SUMMARY OF THE INVENTION

In a first aspect, the invention provides a system for generating and transmitting an alpha-numeric text between a Bluetooth®-enabled communication device and a POGSAG protocol pager including an LCD display to display the text, comprising a pairable Bluetooth®-protocol enabled communication device and transmitter having an input interface for inputting an alpha-numeric text message and a pager number of a non-handshaking POCSAG protocol pager-receiver into the communication device and a Bluetooth®-enabled transmitter for transmitting the alpha-numeric text message and a pager number by radio frequency transmission to a POCSAG protocol transmitter-receiving apparatus configured to receive a Bluetooth®-protocol text by radio frequency transmission; the POCSAG protocol transmitter-receiving apparatus being configured to receive a Bluetooth®-protocol text and pager number and to convert it to a POGSAG protocol numerical code, and having a POGSAG protocol transmitter to transmit the POGSAG protocol numerical code by radio frequency transmission to the non-handshaking POCSAG protocol pager-receiver; wherein the non-handshaking POCSAG protocol pager-receiver has a memory and stored table look-up decoding instructions for converting the received POCSAG protocol numerical code back into the initial alpha-numerical test message, the non-handshaking POCSAG protocol pager-receiver further including an LCD display to ultimately display the text message.

In a second aspect, the invention provides a method for generating and transmitting an alpha-numeric text between a Bluetooth®-enabled communication device and a POGSAG protocol pager including an LCD display to display the text, comprising the steps of: pairing a Bluetooth®-protocol enabled transmitter with a POCSAG protocol transmitter-receiving apparatus configured to receive a Bluetooth®-protocol alpha-numerical text by radio frequency transmission; creating an alpha-numeric text message in the Bluetooth®-enabled communication device for transmission by radio frequency transmission using Bluetooth® protocol by the Bluetooth®-enabled communication device to the POCSAG protocol transmitter-receiving apparatus; entering a pager number of a non-handshaking POCSAG protocol pager-receiver having a memory and stored table look-up decoding instructions for converting the received POCSAG protocol numerical code back into the initial alpha-numerical test message, the non-handshaking POCSAG protocol pager-receiver including an LCD display to ultimately receive the text message; transmitting the alpha-numeric text message and pager number to the POCSAG protocol transmitter-receiving apparatus by radio frequency transmission using Bluetooth® protocol; in the POCSAG protocol transmitter-receiving apparatus, converting the Bluetooth® protocol alpha-numeric text and pager number to POCSAG protocol numerical code corresponding to the Bluetooth® protocol alpha-numeric text and pager number for transmission to the non-handshaking POCSAG protocol pager-receiver; transmitting the POCSAG protocol numerical code by radio frequency transmission to the non-handshaking POCSAG protocol pager-receiver; storing the received POCSAG protocol numerical code in the memory of the POCSAG protocol pager-receiver; by means of the stored table look-up decoding instructions in the memory of the non-handshaking POCSAG protocol pager-receiver, converting the received POCSAG protocol numerical code into the characters of the initial alpha-numeric text message; and displaying the initial alpha-numeric text message on the LCD screen.

In a third aspect, the invention provides a combination Bluetooth®-protocol receiver and POCSAG protocol transmitter, comprising a receiver for receiving a Bluetooth®-protocol text and pager number transmitted using Bluetooth®-protocol by radio frequency transmission; a converter for converting the Bluetooth®-protocol text and pager number to a POCSAG protocol numerical code, and a POCSAG protocol transmitter for transmitting the POGSAG protocol numerical code by radio frequency transmission to a non-handshaking POCSAG protocol pager-receiver.

### BRIEF DESCRIPTION OF THE FIGURES

These and other aspects and advantages of the present invention are further described herein and in the accompanying drawings, wherein:

FIG. 1 illustrates an exemplary system that is directed towards a paging system that employs both POCSAG and Bluetooth® in a restaurant or other hospitality environment.

FIG. 2 illustrates an exemplary ultra-high frequency (UHF) transmitter, configured to receive Bluetooth®-conveyed data, including alphabetic messages composed “on the fly”; a converter for converting this data to POCSAG protocol; and a transmitter to then transmit POCSAG-modulated data using a POCSAG protocol via one or more of the POCSAG radio frequencies (RF) licensed to the manufacturer or provider of its pager devices, including “coaster” type notification pagers.

FIG. 3 illustrates an exemplary Android or iOS® application configured to pair Bluetooth® with an UHF transmitter, such as in FIG. 3.

FIG. 4 illustrates an exemplary method flow chart of initiating a communication at a Bluetooth®-enabled device, wherein an UHF receiver receives the Bluetooth®-modulated communication, including alphabetic text composed “on the fly;” then converts the Bluetooth-conveyed data to POCSAG-modulated protocol, which is then sent to a POCSAG protocol transmitter; and then transmits the POCSAG-modulated data to one or more devices, such as a pager, including a “coaster” type notification pager; which includes a translator for translating the POCSAG-modulated data for a free-form alphabetic text message to text data, and then to display that text data on a display on the pager.

FIG. 5 depicts a user with a cell phone having an Android App for converting spoken words to text sending a text message to a paired Bluetooth Text Data Message, pager number and alert code to a receiver/transmitter, which then sends the text and alert code using UHF and POCSAG protocol to a pager/receiving which then alerts and displays the text message on an LCD display.

FIG. 6 is a flow chart showing the initial steps of pairing Bluetooth with the transmitter and using the cell phone feature to convert voice to text or keyboard to text.

FIG. 7 depicts Bluetooth tags for the alpha-numeric pagers and the guest pagers (non-alpha).

### DETAILED DESCRIPTION OF THE EMBODIMENTS

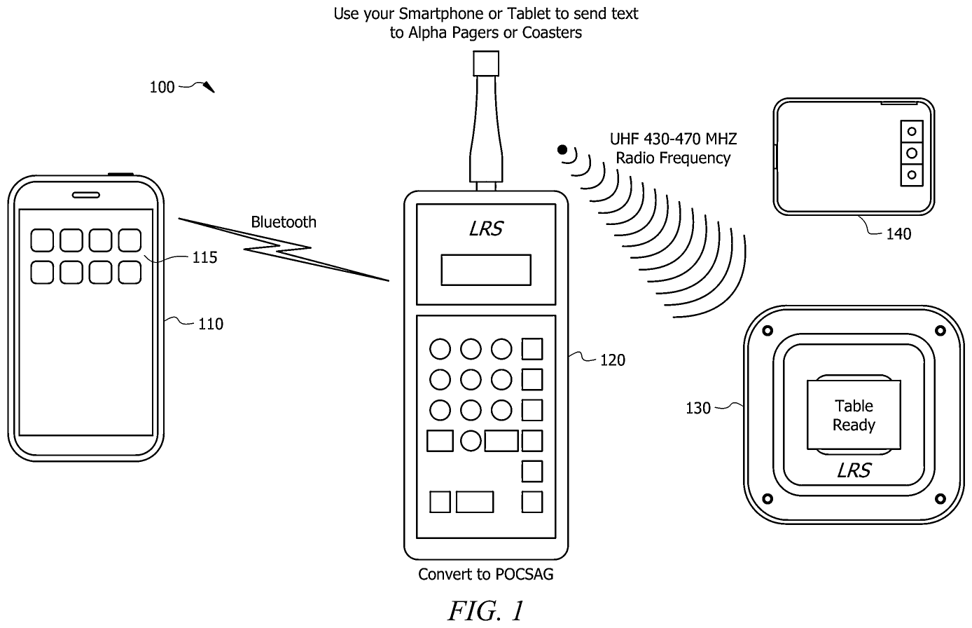

Referring now to the drawings in detail, FIG. 1 depicts a system 100 for converting between Bluetooth® and/or IP protocol to POCSAG for paging, such as in a restaurant or other hospitality environment. A communications device 110, such as a cell phone, includes a downloaded application 115 for communicating over Bluetooth® with a modified UHF transceiver. The application 115 is configured to accept alphabetic and numeric texts composed “on the fly” from a user and then transmit them according to Bluetooth® protocol, which will then translate that message from Bluetooth® protocol into POCSAG protocol for transmission to the pager or pages.

In one embodiment, a UHF transceiver 120 is configured to convert between Bluetooth® alphanumeric text that are received from the application 115 into POCSAG protocol that was intended for transmission only of numbers, including the identifier of the pager device to be communicated with, and then to transmit the converted message out as a POCSAG page using POCSAG protocol. In one aspect, this frequency can be in the UHF 430-470 MHz radio frequency. For information regarding POCSAG, please see the Wikipedia article “Radio-paging code No. 1” of Sep. 30, 2019 (https://en.wikipedia.org/wiki/Radio-paging_code_No._1) which is hereby incorporated by reference in its entirely. For information regarding Bluetooth®, please see the Wikipedia article “Bluetooth” as of Sep. 30, 2019 (https://en.wikipedia.org/wiki/Bluetooth) which is hereby incorporated by reference in its entirety.

A pager 130, such as a “coaster” pager commonly used in a restaurant environment, is configured to receive the POCSAG page. In the present invention, however, that message can include a coded translation of the “on the fly” alphabetic text message that was composed “on the fly,” which was transmitted by means of the Bluetooth® signal. A pager, such as an alphanumeric pager 140, is also configured to receive the POCSAG page, which includes the embedded alphabetic text of the original Bluetooth® signal. This text, including at least some alphabetic characters composed “on the fly,” and possibly some numerical information as well, such as the sender's telephone number, are then displayed on its liquid crystal display (LCD) screen.

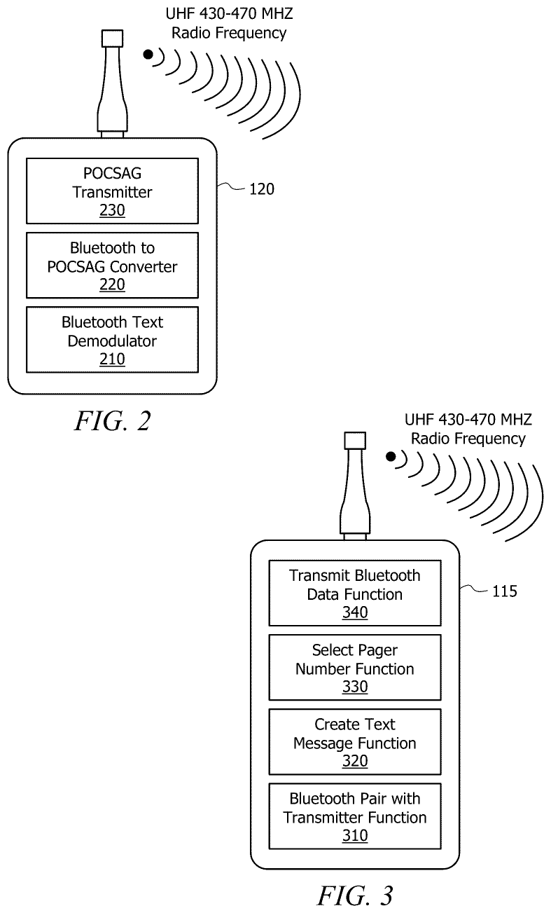

Turning now to FIG. 2, illustrated is a UHF transmitter 200 configured to convert Bluetooth® to POCSAG. For one example of a UHF transmitter, please see U.S. Patent Application No. U.S. 20190381972A1, entitled “Portable device, on-board device, and wireless communication system for vehicles”, which is hereby incorporated by reference in its entirety.

In a Bluetooth®/IP text demodulator 210, a Bluetooth® signal, including a destination pager number, or alternatively an ALL pager command, and an embedded text, is received. For an exemplary Bluetooth demodulator, please see U.S. Application Publication No. U.S. 20060115019A1, entitled “Complex digital phase locked loop for use in a demodulator and method of optimal coefficient selection”, which is hereby incorporated by reference in its entirely.

In a Bluetooth®/IP to POCSAG converter 220, the embedded text is received from the Bluetooth® text receiver converter. Here, the Bluetooth signal, including the embedded text message and the pager-identification number, is converted to POCSAG.

The present application achieves greater efficiency by integrating existing infrastructure configured in POCSAG, which conventionally is configured only to send pre-set messages. In particular, in a POCSAG transmitter 230, the converted POCSAG signal is transmitted. In one embodiment, this is a UHF signal in the 430-470 MHz Radio Frequency range. This message includes the embedded alphabetic text message received from device 110. For one example of converting binary data into POCSAG, please see European Patent No. “EP0153835A2 entitled “Radio receiver”, which is hereby incorporated by reference in its entirety.

Turning now to FIG. 3, illustrated is a diagram for application 115 for communicating with the transmitter 120. This application 115 can be configured for a plurality of operating systems, e.g., an Android® or for iOS®.

In a Bluetooth® pair with transmitter function 310, the application 115 pairs with the transmitter 120.

In a create text message function 320, a text message is created. This can occur with employment of, for example, a keyboard or a microphone. This text message typically includes adjacent information such as the sender's identification, e.g., the cell phone number of the communications device 110.

In a select pager function 330, either a particular pager number is selected, or alternatively all the pagers that are coupled with a particular transmitter 120 are selected by means of, for example, the ALL command.

In a transmit data function 340, the text, the sender information and target pager number (or all pagers) information and command is then be transmitted to the Bluetooth®-to POCSAG UHF transmitter 120.

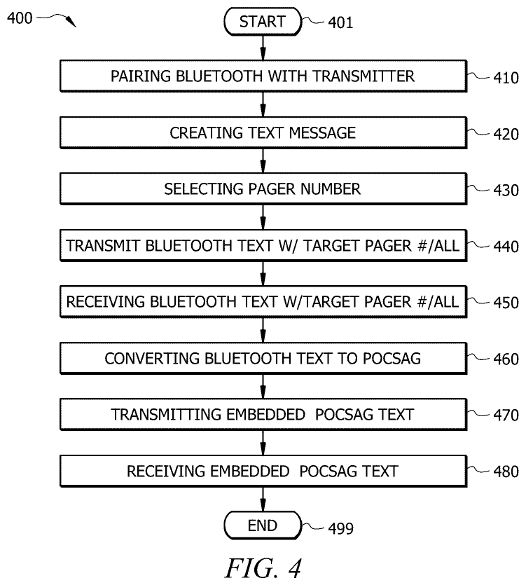

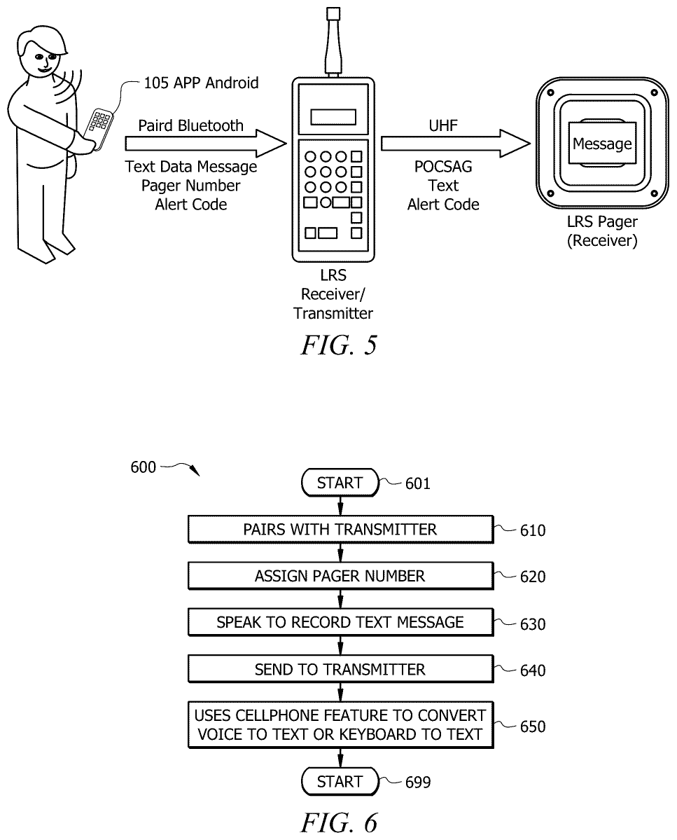

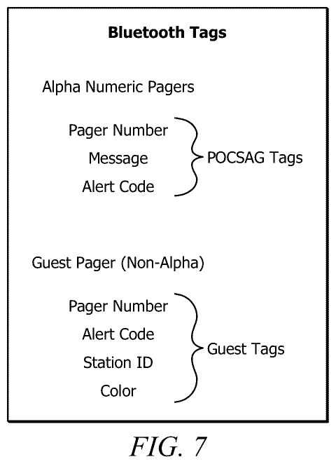

FIG. 4 illustrates an exemplary method 400 for conveying a text between a Bluetooth®-enabled communication device, such as device 110, and a POGSAG protocol pager such as a restaurant “coaster” type pager 130, including an LCD display.

The method starts at step 401.

In a step 410, a pairing between Bluetooth® transmitter and a transmitter, such as the transmitter 120, occurs.

In a step 420, a text message is created in a Bluetooth® environment, such as provided by the communications device 110.

In a step 430, a pager target number, or alternatively all pager numbers, are targeted for communication from the device, such as the communications device 110, with a text.

In a step 440, the Bluetooth® data, including the selected pager number or a ALL command (e.g., all pagers configured to respond to a command), is transmitted.

In a step 450, the Bluetooth® data, including the selected pager target number or ALL command are received.

In a step 460, the Bluetooth® data, data, including the selected pager target number or ALL command, is converted into POCSAG data.

In a step 470, the POCSAG data is transmitted. The POCSAG data can include both the “on the fly” composed of alphabetic data which has been converted to numbers for transmission to the pager, which can then translate the numbers into letters with a table look-up stored in the pager, as well as, when desired, transmit a numeric identifier of the originating 1 communications device 120, such as its cell phone number.

In a step 480, the POCSAG data is received by the pagers, such as alpha pagers 140 or coaster pagers 490.

The method 400 ends in a step 499.

Any of the functions disclosed herein may be implemented using any means for performing those functions. Such means include, but are not limited to, any of the components disclosed herein, but also includes computer-related components such as those described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more machines, such as computers, computer processors, and/or other elements of a computer system. Such features are either impossible or impractical to implement mentally and/or manually. For example, embodiments of the present invention read data from a machine-readable object, such as by using a wand to read data from a chip. This function cannot be performed by a human manually or mentally.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s).

Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors.

Generally, the processor receives (reads) instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic discs such as internal hard discs and removable discs; magneto-optical discs; and CD-ROMs. Any of the foregoing may be supplemented by, or incorporated in, specially designed ASICs (application-specific integrated circuits) or FPGAs (Field-Programmable Gate Arrays).

A computer can generally also receive (read) programs and data from, and write (store) programs and data to, a non-transitory computer-readable storage medium such as an internal disc (not shown) or a removable disc. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A system for generating and transmitting an alpha-numeric text between a Bluetooth®-enabled communication device and a POGSAG protocol pager including an LCD display to display the text, comprising:
a pairable Bluetooth®-protocol enabled communication device and transmitter having an input interface for inputting an alpha-numeric text message and a pager number of a non-handshaking POCSAG protocol pager-receiver into the communication device, the transmitter having a Bluetooth®-enabled transmitter for transmitting the alpha-numeric text message and a pager number by radio frequency transmission to a POCSAG protocol transmitter-receiving apparatus configured to receive a Bluetooth®-protocol text by radio frequency transmission;
the POCSAG protocol transmitter-receiving apparatus being configured to receive the Bluetooth®-protocol text and pager number and to convert it to a POGSAG protocol numerical code, and having a POGSAG protocol transmitter to transmit the POGSAG protocol numerical code by radio frequency transmission to a non-handshaking POCSAG protocol pager-receiver; and
the non-handshaking POCSAG protocol pager-receiver having a memory and stored table look-up decoding instructions for converting the received POCSAG protocol numerical code back into the initial alpha-numerical test message, the non-handshaking POCSAG protocol pager-receiver further including an LCD display to ultimately display the text message.

2. A method for generating and transmitting an alpha-numeric text between a Bluetooth®-enabled communication device and a POGSAG protocol pager including an LCD display to display the text, comprising the steps of:
pairing a Bluetooth®-protocol enabled transmitter with a POCSAG protocol transmitter-receiving apparatus configured to receive a Bluetooth®-protocol alpha-numerical text by radio frequency transmission;
creating an alpha-numeric text message in the Bluetooth®-enabled communication device for transmission by radio frequency transmission using Bluetooth® protocol by the Bluetooth®-enabled communication device to the POCSAG protocol transmitter-receiving apparatus;
entering a pager number of a non-handshaking POCSAG protocol pager-receiver having a memory and stored table look-up decoding instructions for converting the received POCSAG protocol numerical code back into the initial alpha-numerical test message, the non-handshaking POCSAG protocol pager-receiver including an LCD display to ultimately display the text message;
transmitting the alpha-numeric text message and pager number to the POCSAG protocol transmitter-receiving apparatus by radio frequency transmission using Bluetooth® protocol;
in the POCSAG protocol transmitter-receiving apparatus, converting the Bluetooth® protocol alpha-numeric text and pager number to POCSAG protocol numerical code corresponding to the Bluetooth® protocol alpha-numeric text and pager number for transmission to the non-handshaking POCSAG protocol pager-receiver;
transmitting the POCSAG protocol numerical code by radio frequency transmission to the non-handshaking POCSAG protocol pager-receiver;
storing the received POCSAG protocol numerical code in the memory of the POCSAG protocol pager-receiver;
by means of the stored table look-up decoding instructions in the memory of the non-handshaking POCSAG protocol pager-receiver, converting the received POCSAG protocol numerical code into the characters of the initial alpha-numeric text message; and
displaying the initial alpha-numeric text message on the LCD screen.

3. A combination Bluetooth®-protocol receiver and POCSAG protocol transmitter, comprising:
a receiver for receiving a Bluetooth®-protocol text and pager number transmitted using Bluetooth®-protocol by radio frequency transmission;
a converter for converting the Bluetooth®-protocol text and pager number to a POCSAG protocol numerical code; and
a POCSAG protocol transmitter for transmitting the POGSAG protocol numerical code by radio frequency transmission to a non-handshaking POCSAG protocol pager-receiver.
